(19) United States
(12) Patent Application Publication
(10) Pub. No.: US 2003/0127103 A1
(43) Pub. Date: Jul. 10, 2003

(54) Removable backboard stand and method for its use

(75) Inventor: Rodney Brenneman, San Juan Capistrano, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THERACARDIA, INC., San Clemente, CA (US)

(21) Appl. No.: 10/043,560

(22) Filed: Jan. 9, 2002

(51) Int. Cl. A61G 1/04; A61G 1/06; A61G 7/005

(52) U.S. Cl. 128/845; 128/870; 128/878; 128/882

(57) ABSTRACT

Patients on immobilization backboards may be elevated by selective attachment to a separate stand. The stand may be attached to the foot end of the backboard to raise the patient's feet. The stand may be attached to the head end of the backboard to raise a patient's head. The stands are collapsible for convenient storage. Optionally, straps or other mechanisms are provided for selectively attaching a patient's ankle or arms to the backboard while the patient is elevated.

### BACKGROUND OF THE INVENTION

1. Field of the Invention

The present invention relates generally to medical devices and methods. In particular, the present invention relates to apparatus and methods for elevating patients on backboards in emergency response situations.

Patients suffering from sudden cardiac arrest often receive initial treatment from emergency response teams in ambulances or other emergency vehicles. Such patients typically receive cardiopulmonary resuscitation (CPR) including airway support and closed chest heart massage or compression. Recently, apparatus and methods for minimally invasive direct heart compression, optionally combined with defibrillation, have been proposed, referred to as MID-CM. It has long been known that closed chest heart compression is limited in its ability to achieve coronary perfusion, i.e., supply oxygenated blood to the heart to prevent damage to heart tissue. While MID-CM can achieve significantly greater cardiac output and blood flow to the heart, cardiac output is still limited to about 50% to 60% of normal physiologic output.

One limit to both conventional CPR and more advanced MID-CM is refilling of the ventricles during diastole. A variety of methods to enhance heart refilling have been proposed over the years. Suggestions have sometimes been complex, e.g., the use of inflatable “military antishock trousers” for applying pressure to the legs to decrease total vascular volume and enhance blood flow back to the heart. More simply, it has been proposed to raise the patient's legs above the heart, referred to as the Trendelenburg position. Most standard hospital gurneys are adjustable so that the patient may be placed into the Trendelenburg position when appropriate. Certain stretchers have also been modified to allow such positioning.

Such specialized equipment for positioning a patient in the Trendelenburg position has generally not been available in the field where emergency response teams typically administer initial treatment. Thus, when employing CPR or the more advanced MID-CM resuscitation, patients are typically on the ground or have been placed on a flat panel intended for patient immobilization and transport, typically referred to as a “backboard.” Backboards are widely commercially available, and generally consist of a metal or plastic panel having numerous openings spaced about their peripheries to provide hand holds for manual lifting and transport. Typically, the backboards will also be provided with, or adapted to receive, straps for holding the patient onto the backboard.

It has been proposed by others to modify the design of patient backboards to incorporate integral structure to allow selective raising of one end to permit positioning of the patient in the Trendelenburg position. While such an approach would be theoretically effective, it is economically impractical. The emergency care provider would either have to maintain an inventory of two types of backboard in every emergency response vehicle or switch the entire inventory over to the more complex and expensive backboard having a raising mechanism at one end. Neither approach is economically satisfactory. However, use of the more complicated, and presumably heavier backboard with the integral raising mechanism would complicate treatment and transport of patients not requiring positioning in the Trendelenburg position.

For all these reasons, it would be desirable to provide improved methods and apparatus which permit the selective elevation of patients using conventional patient backboards. It would be particularly desirable if such methods and apparatus were compatible with most or all commercially available patient backboards, were simple to use, were low cost, and relatively compact so that they would take up minimum space on emergency vehicles. In addition, it would be further desirable if the apparatus permitted adjustment of the height to which the backboard were to be raised and permitted selective immobilization of the patient to prevent the patient from sliding off the elevated backboard. At least some of these objectives would be met by the inventions described hereinafter.

2. Description of the Background Art

Emergency response backboards are available from a number of commercial suppliers, such as Galls, Inc. under the Dyna Med brand name, Ambu International, and the like. MID-CM is described in U.S. Pat. Nos. 5,466,221; 5,683,364; 5,978,714, and 6,296,653, the full disclosures of which are incorporated herein by reference.

### BRIEF SUMMARY OF THE INVENTION

The present invention provides improved methods and apparatus for elevating patients who have been placed on backboards, typically in emergency response situations. The term “backboard” refers to any conventional panel-like device intended for patient immobilization and transport. The backboards will typically consist of a flat metal of polymeric panel having a length of 180-200 cm. and a width of approximately 40-50 cm, although these dimensions will of course vary. The panels will have numerous slots or apertures about their periphery intended to define handholds to facilitate manual holding and carrying of the panels when the patient is present. Additional slots may be provided for placement of straps to hold the patient on top of the backboard, and often the straps will be provided with the backboard. Generally, no other or capabilities will be required on the backboard to be used with the methods and apparatus of the present invention.

The present invention provides for selective elevation of either or, in some instances, both ends of the backboard when it is determined that such elevation is desirable. That is, the patients will be placed on the backboard and optionally strapped or otherwise immobilized on the backboard in a conventional manner. Then, if the treating person determines that it is necessary or desirable, at least one end of the backboard will be elevated using a separate stand as will be described in detail below. The stand will be dimensioned to raise the end of the backboard to a desired height above the surface upon which the backboard has been placed, typically in the range from 25 cm to 160 cm, usually from 60 cm to 100 cm. When treating patients suffering from sudden cardiac arrest, it will usually be the foot end of the board which is raised, i.e., the end of the board at which the patient's feet have been placed. In other instances, however, it may be desirable to raise the head end of the board, i.e., the end of the board at which the patient's head has been placed. In all instances, the stand may have the capability of securing the feet or head of the patient, whichever has been raised by the stand. For example, when treating patients by CPR or MID-CM, straps on the stand may be attached to the patient's ankles to hold the patient in place. This is particularly advantageous since securing the patient by the ankles permits fewer or no straps to be placed over the patient's chest, leaving the chest available for CPR, MID-CM, or other interventions.

In a first aspect, methods according to the present invention comprise providing a backboard and providing a stand. The stand will have the bottom adapted for stable placement on a flat surface, such as the ground, and an attachment mechanism disposed above the bottom by a distance in the range from 25 cm to 160 cm, typically 60 cm to 100 cm. The attachment mechanism is adapted to be removably connected to one end of the backboard. After placing the patient on the backboard, one end of the backboard is attached to the attachment mechanism on the stand to achieve the desired elevation. Optionally, the emergency responder may determine whether the patient would benefit from the Trendelenburg position. If so, the stand will be attached to the foot end of the backboard. Further alternatively, straps on the stand may be attached to the patient's ankles when the patient has been elevated in the Trendelenburg position.

Attachment of the backboard to the stand may be achieved in a wide variety of ways. In the exemplary embodiment, straps are provided at the top of the stand, which extend through handholds on the backboard to achieve the desired attachment. Other attachment mechanisms, such as brackets, cords, hooks, and the like, could be utilized with or in place of the illustrated straps. Further optionally, the height of the stand may be adjusted to control the distance of the attachment mechanism above the bottom of the stand. For example, the stand may comprise legs having telescope mechanisms to permit height adjustment of the legs.

In a second aspect, methods according to the present invention comprise providing a backboard and providing a stand generally as described above. One end of the backboard is attached to the stand to elevate the stand, optionally in advance of placing the patient on the backboard. Other aspects of the method described above apply to this alternative method as well.

In a third aspect of the present invention, a stand for removable connection to a patient backboard comprises a structure having a bottom adapted for stable placement on a flat surface. The structure further includes a superstructure which extends vertically from the bottom when the bottom is on a horizontal flat surface. An attachment mechanism is disposed on the superstructure and elevated above the bottom by distance in the range from 25 cm to 160 cm, typically 60 cm to 100 cm. The attachment mechanism is adapted to removably secure one end of the patient backboard, typically by attachment to handholds at the end of the backboard.

The stand may further comprise straps for immobilizing the patient on a backboard, e.g., straps intended for securing a patient's ankles or for holding the patient under the patient's arms. In the exemplary embodiment, the structure comprises a pair of U-shaped legs which are hinged together at their upper ends in order to permit folding of the structure for storage. Optionally, the legs may be individually telescoping to permit both collapsing of the device for storage and height adjustment for use.

### BRIEF DESCRIPTION OF THE DRAWINGS

FIG. 1 is a perspective view of a backboard elevation stand constructed in accordance with the principles of the present invention.

FIG. 2 illustrates a conventional patient backboard having a plurality of handholds and strap slots thereon.

FIG. 3 is a detailed view of the attachment of one end of the backboard of FIG. 2 to the backboard attachment stand of FIG. 1.

FIG. 4 illustrates positioning of a patient on the backboard of FIG. 2 using the backboard elevation stand of FIG. 1.

### DETAILED DESCRIPTION OF THE INVENTION

A backboard elevation stand 10 constructed in accordance with the principles of the present invention comprises a pair of U-shaped legs 12 which are hinged together along the upper bars 14 which connect the individual legs together. The individual legs include the telescoping sections 16 which may be adjusted using conventional detent mechanisms 18. Usually, the legs will have rubber feet 20 which permit placement on a flat surface 22, typically a floor in the region where the patient is to be received and treated.

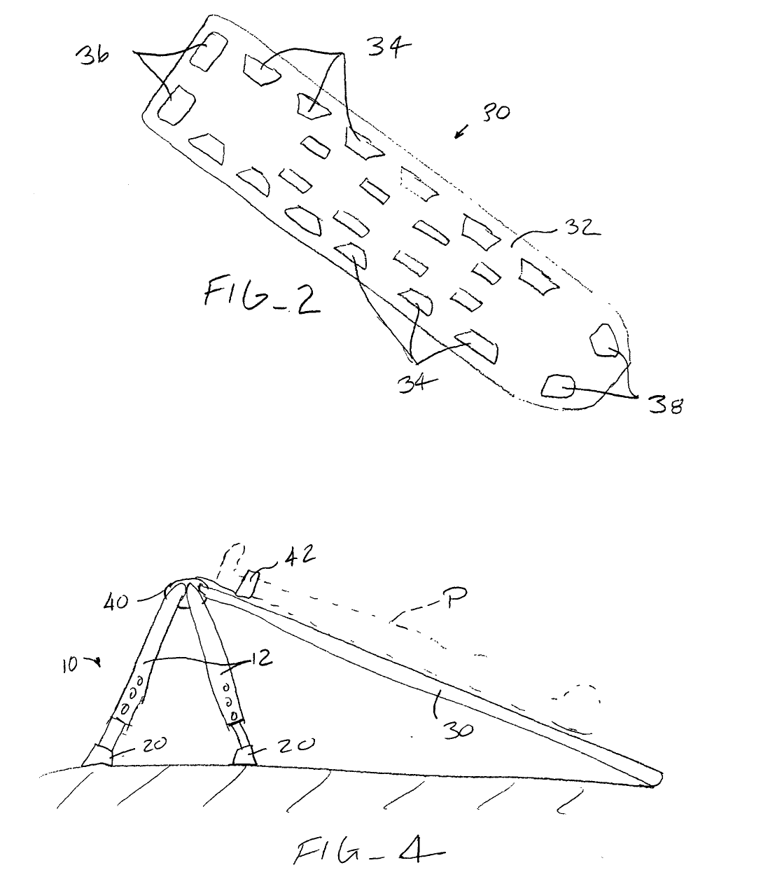

The upper bars 14 define the superstructure of the stand to which the backboard will be connected. Referring now to FIG. 2, the backboard 30 comprises a flat panel 32 having the dimensions described above. Handholds 34 are formed along each side, with handholds 36 and 38 formed at the foot and head ends, respectively.

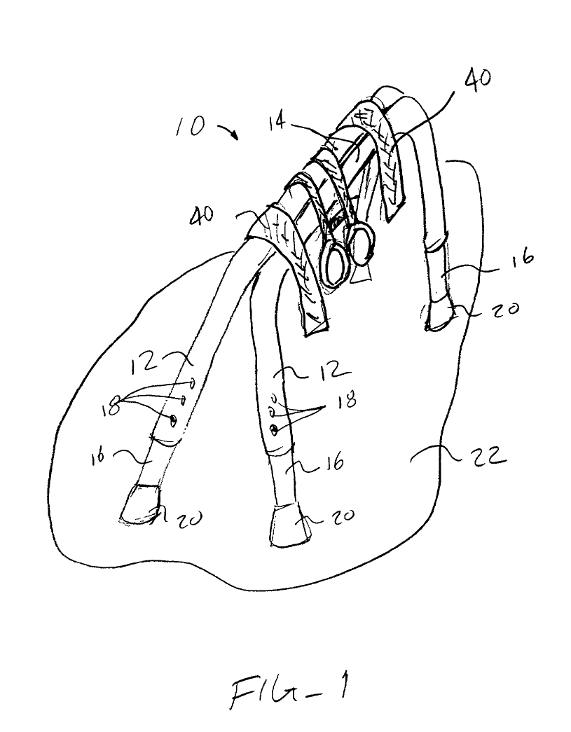

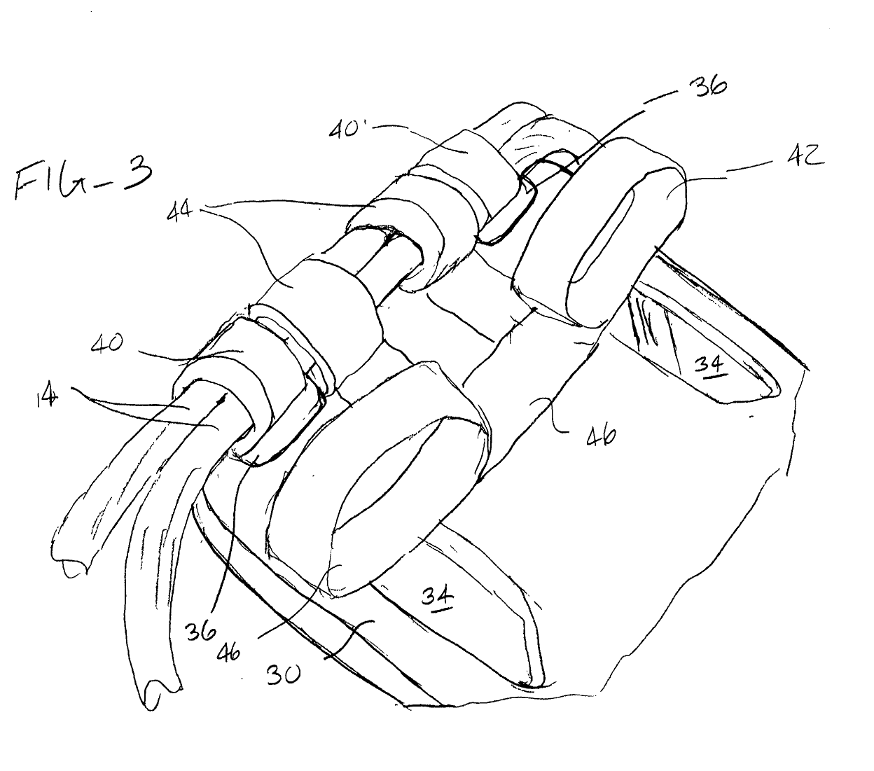

Referring now to FIGS. 1 and 3, the foot end of the backboard 2 may be connected to the upper bars 14 using straps 40. Straps 40 will typically comprise hook-and-loop fasteners, such as those commercially available under the tradename Velcro, allowing the straps to be placed through the handholds 36 as illustrated in FIG. 3. In addition to straps 40, ankle straps 42 are provided and are connected to the upper bars 14 using connector straps 44 and are tied together using a cross strap 46. Typically, the straps 42 and 44 will also comprise hook-and-loop fasteners to permit ready attachment and removal from the stand. Alternative strap mechanisms can be provided for attachment to the upper bars 14 to permit patient immobilization under the arms for use when the backboard will be elevated at the head end.

Referring now to FIG. 4, placement of a patient P in the Trendlenburg position is usually carried out by first positioning the patient on the upper surface of the backboard 30. The patient's feet will then be strapped directly to the stand using ankle straps 42 and the foot end of the backboard is then elevated and attached to the stand 10 using straps 40. The patient is then available for CPR, MID-CM, or other techniques to achieve resuscitation.

What is claimed is:

1. A method for elevating a patient, said method comprising:
providing a backboard;
providing a stand having a bottom adapted for stable placement on a flat surface and an attachment mechanism disposed above the bottom by a distance in the range from 25 cm to 160 cm, wherein the attachment mechanism is adapted to removably connect to one end of the backboard;
placing a patient on the backboard; and
attaching at least one end of the backboard to the attachment mechanism on the stand to elevate the end.

2. A method as in claim 1, further comprising determining whether the patient would benefit from the Trendelenburg position and, if so, attaching the stand to a foot end of the backboard.

3. A method as in claim 2, further comprising connecting straps on the stand to the patient's ankles to help hold the patient on the backboard.

4. A method as in claim 1, wherein attaching comprises connecting straps on the stand through holes at the end of the backboard.

5. A method as in claim 1, further comprising adjusting the stand to adjust the distance of the attachment mechanism above the bottom of the stand.

6. A method for elevating a patient backboard, said method comprising:
providing a backboard;
providing a stand having a bottom adapted for stable placement on a flat surface and an attachment mechanism disposed above the bottom by a distance in the range from 25 cm to 160 cm, wherein the attachment mechanism is adapted to removably connect to one end of the backboard; and
attaching at least one end of the backboard to the attachment mechanism on the stand to elevate the end.

7. A method as in claim 6, wherein attaching comprises connecting straps on the stand through holes at the end of the backboard.

8. A method as in claim 6, further comprising adjusting the stand to adjust the distance of the attachment mechanism above the bottom of the stand.

9. A stand for removable connection to a patient backboard, said stand comprising:
a structure having a bottom adapted for stable placement on a flat surface and a superstructure which extends vertically when the bottom is on a horizontal flat surface; and
an attachment mechanism on the superstructure, said attachment mechanism disposed above the bottom by a distance in the range from 25 cm to 160 cm, wherein said attachment mechanism is adapted to removably secure one end of a patient backboard.

10. A stand as in claim 9, further comprising straps for immobilizing a patient on a backboard which has been elevated with the stand.

11. A stand as in claim 10, wherein the straps are adapted for removably securing a patient's ankles.

12. A stand as in claim 10, wherein the straps are adapted for removably securing under a patient's arms.

13. A stand as in claim 9, wherein the structure comprises a pair of U-shaped legs hinged together at their upper ends.

14. A stand as in claim 13, wherein the legs are individually telescoping.
